(19) United States
(12) Patent Application Publication
(10) Pub. No.: US 2004/0032865 A1
(43) Pub. Date: Feb. 19, 2004

(54) Apparatus and method for establishing a call connection state in a packet data communication system

(75) Inventor: Eun-Hyun Kwon, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Pharmacia Corporation, St. Louis, MO

(21) Appl. No.: 10/637,547

(22) Filed: Aug. 11, 2003

(30) Foreign Application Priority Data
Aug. 16, 2002 (KR) 2002-48472

(51) Int. Cl. H04L 12/50

(52) U.S. Cl. 370/367; 370/902

(57) ABSTRACT

Apparatus and method for establishing call connection state in packet data communication system. The apparatus controls a Service General Packet Radio Service (GPRS) Support Node (SGSN) to avoid establishing a call connection state associated with an erroneous Gateway GPRS Support Node (GGSN). The SGSN attempts to establish a call connection state with a GGSN connected to the SGSN, and stores the attempt result information in a specific memory. In this case, the memory stores information indicating success or failure of the attempt directed to the specific GGSN, and call setup attempt time information, etc. Thereafter, if a call setup operation associated with the specific GGSN is re-attempted, then information associated with the specific GGSN is read from information pre-stored in the memory. Based on the read information, it is determined whether a call setup operation directed to the specific GGSN is reattempted, or another call setup operation directed to another GGSN is newly attempted.

### PRIORITY

This application claims priority to an application entitled “APPARATUS AND METHOD FOR ESTABLISHING CALL CONNECTION STATE IN PACKET DATA COMMUNICATION SYSTEM”, filed in the Korean Industrial Property Office on Aug. 16, 2002 and assigned Serial No. 2002-48472, the contents of which are incorporated herein by reference.

### BACKGROUND OF THE INVENTION

1. Field of the Invention

The present invention relates to a packet data communication system, and more particularly to an apparatus and method for establishing a call connection state for performing packet data transmission without selecting an erroneous node.

2. Description of the Related Art

Typically, a mobile communication system is a service system for providing users or subscribers with voice signals or data. The mobile communication system is classified into various kinds of mobile systems according to multiplexing types. A representative example of such a mobile communication system is a Code Division Multiple Access (CDMA) mobile communication system. The CDMA mobile communication system has developed from the IS-95 standard, designed for mainly performing transmission/reception of voice signals, to the next generation mobile communication standards required for transmitting not only the voice signals, but also high-speed data. The next generation mobile communication standards aim to provide users or subscribers with high-quality audio or video and moving picture data, and Internet search services, etc.

A variety of switched networks have been developed for providing users with various information such as voice or data information in the aforementioned mobile communication system. Representative examples of such switched networks are a circuit switched network and a packet switched network. The circuit switched network is adapted to control circuit data including voice or audio data, and the packet switched network is adapted to control packet data. A mobile communication system for controlling such packet data in the packet switched network is called a packet data communication system.

There is a need for the mobile communication system to have a network configuration for effectively transmitting voice signals and data. Particularly, this circuit configuration is more critical to the next generation mobile communication systems such as the International Mobile Telecommunications (IMT)—2000 which require large amounts of data to be transmitted for a variety of communication services. Therefore, a General Packet Radio Service (GPRS) based on a conventional circuit switched Global System for Mobile Communication (GSM) network has recently been developed. The most important purpose of a packet data service such as the GPRS is to provide users with conventional Internet application services, for example, wireless file transfer services and E-mail transmission/reception services using a Personal Computer (PC), and Internet search services through the World Wide Web (WWW).

Typically, GPRS is classified into a terminal part, an access part, and a core network. The access part includes a base station, and a wireless network controller. The core network includes a Service GPRS Support Node (SGSN) and a Gateway GPRS Support Node (GGSN).

FIG. 2 is a block diagram illustrating an example of a stack configuration of a conventional packet data mobile communication system.

A Packet Data Protocol (PDP) context activation procedure between a Mobile Station (MS) and a GGSN will hereinafter be described with reference to FIG. 2.

Firstly, a control tunnel for transmitting packet data is created between a mobile terminal and a GGSN to activate the PDP context. A user tunnel for transmitting the packet data is then created. A method for creating a control tunnel between the SGSN and GGSN from among several methods for creating control tunnels associated with embodiments of the present invention will hereinafter be described in more detail.

The GPRS adapts an Access Point Name (APN) to activate the PDP context. The APN is an identifier (ID) for indicating a position of a packet data server to be connected with a user. Each packet data server provides a user with specific packet data upon receiving a request from the user, and has a Fully Qualified Domain Name(FQDN) a unique ID that varies with the APN information. The packet data servers are classified by the APN.

A GMM/SM/SMS layer contained in a SGSN shown in FIG. 2 converts the APN into an FQDN, and acquires an Internet Protocol (IP) address of a GGSN connected from a Domain Name System (DNS) server to the packet data server. The DNS server manages records associated with the packet data servers and GGSN records associated with each packet data server. Therefore, if an FDQN received from the SGSN requests the DNS server to answer an IP address of a GGSN for providing a real packet data service later, the DNS server searches for an IP address of the GGSN using the FQDN. The DNS server informs the SGSN of the IP address found by the FQDN. Thus, if an IP address of the GGSN for providing the real packet data service later is acquired, an IP layer of the SGSN communicates with an IP layer of the GGSN using an IP.

FIG. 3 is a block diagram illustrating an example of a procedure where creating a control tunnel between a SGSN and a GGSN fails in a general packet data mobile communication system. Specifically, if a control tunnel from a SGSN to a GGSN is not created, a method for creating a new control tunnel directed to another GGSN instead of the erroneous GGSN is shown in FIG. 3.

Referring to FIG. 3, a MS requests information from a DNS server 302 concerning an IP address of a GGSN connected to a packet data server desiring packet data in a GMM/SM/SMS layer contained in the SGSN. Upon receiving the inquiry from the MS, the DNS server 302 informs the MS of the IP address of at least one GGSN connected to the packet data server. Provided that a plurality of GGSNs having the same IP APNs provide a MS with their services, a plurality of IP addresses may be transmitted to the MS. FIG. 3 shows an example where two GGSNs 308 and 310 are connected to a specific packet data server. The GGSN 308 is called a first GGSN, and the other GGSN 310 is called a second GGSN, as shown in FIG. 3. Upon receiving one IP address from the DNS server 302, the SGSN 300 performs a communication function to create a control tunnel directed to a GGSN associated with the received IP address. However, upon receiving a plurality of IP addresses from the DNS server 302, the SGSN 300 selects a specific IP address from among the plurality of IP addresses, and performs a communication function to create a control tunnel directed to a GGSN associated with the selected IP address. FIG. 3 shows an example for selecting an IP address associated with the first GGSN 308 from between two IP addresses. If a control tunnel is created as above, the SGSN 300 creates a user tunnel for transmitting real packet data to a corresponding GGSN.

However, if a control tunnel between the SGSN 300 and the first GGSN 308 is not created, the SGSN 300 performs a communication function to create another control tunnel directed to the second GGSN 310 associated with the next IP address. Such control tunnel creation failure may occur due to internal factors of the first GGSN 308, or may occur in a path for creating the control tunnel. If the control tunnel between the SGSN 300 and the second GGSN 310 is successfully created, the SGSN 300 attempts to create the user tunnel for transmitting the real packet data to the second GGSN 310.

When there are a plurality of GGSNs for supporting a desired packet data service in a conventional packet data communication system, the plurality of GGSNs are sequentially selected until the PDP context is activated, such that a procedure for creating a control tunnel is performed. Specifically, if the SGSN receives IP addresses corresponding to the plurality of GGSNs from the DNS server, the SGSN attempts to activate the PDP context using an IP address corresponding to one specific GGSN from among the plurality of GGSNs. In this case, there is a communication failure in the above specific GGSN attempting to activate the PDP context, the SGSN selects another GGSN from among the plurality of GGSNs, instead of selecting the erroneous specific GGSN, and then attempts to activate the PDP context. In this case, the SGSN does not additionally manage information of the erroneous specific GGSN. Therefore, it is difficult for the conventional packet data communication system to avoid attempting to create a control tunnel associated with the erroneous GGSN when activating the PDP context upon receiving a new request for the same service from a user. In other words, the conventional packet data communication system may reply to the same packet data service request from another mobile terminal using the erroneous GGSN failing to create the control tunnel, and may attempt to create a new control tunnel using the erroneous GGSN. In this case, it is expected that creating a control tunnel from the SGSN to the GGSN will inevitably fail. Due to a retry operation for creating such a control tunnel directed to the erroneous GGSN, a specific time at which a PDP context activation directed to a normal or good GGSN having no error is undesirably delayed.

### SUMMARY OF THE INVENTION

Therefore, the present invention has been developed in view of the above problems, and it is an object of the present invention to provide a method and apparatus for managing status information associated with an erroneous GGSN in a SGSN.

It is another object of the present invention to provide a method and apparatus for controlling a SGSN to avoid selecting an erroneous GGSN.

It is yet another object of the present invention to provide a method and apparatus for enhancing a packet call success rate by not activating a PDP context associated with an erroneous GGSN.

It is yet another object of the present invention to provide a method and apparatus for reducing the amount of traffic by avoiding unnecessary retries, resulting in a reduction of internal network resources.

Each SGSN has a memory. The memory stores an IP of a GGSN communicating with an external data network, a time at which the SGSN attempts to create a control tunnel directed to the GGSN, and information indicating success or failure of the attempt. The SGSN resets the time information at which creating a control tunnel directed to the GGSN is attempted and the attempt result information indicating the success or failure of the attempt at intervals of a predetermined time. The above information is reset to support the possibility of a change of network configuration information and remove a communication failure associated with a specific GGSN.

In accordance with embodiments of the present invention, the above and other objects can be substantially accomplished by the provision of a method for creating a control tunnel from a Service General Support Node (SGSN) General Packet Radio Service (GPRS) to a Gateway GPRS Support Node (GGSN) when setting up a path for providing a specific packet data service between a Mobile Station (MS) and a packet data server in a mobile communication system for supporting a packet data service, comprising the steps of: a) upon receiving a specific packet data service request from the MS, enabling the SGSN to determine an Internet Protocol (IP) address corresponding to at least one GGSN connected to the packet data server for providing the specific packet data service; b) receiving control tunnel creation attempt result information managed by a memory in association with the determined IP address, and determining whether communication failure information is found in the received result information; and c) if there is no communication failure information, enabling the SGSN to attempt to create a control tunnel directed to a GGSN having the determined IP address.

In accordance with embodiments of the present invention, there is also provided an apparatus for creating a control tunnel from a Service General Support Node (SGSN) to a Gateway General Packet Radio Service(GPRS) Support Node (GGSN) when setting up a path for providing a specific packet data service between a Mobile Station (MS) and a packet data server in a mobile communication system for supporting a packet data service, comprising: an Access Point Name (APN) translator for receiving a specific packet data service request from the MS, enabling the SGSN to determine an Internet Protocol (IP) address corresponding to at least one GGSN connected to the packet data server for providing the specific packet data service; a memory for storing an IP address of at least one GGSN according to individual identifiers (IDs) of packet data servers for previously providing packet data service, and managing control tunnel creation attempt result information associated with the IP address; and a control tunnel creator for receiving the control tunnel creation attempt result information managed by the memory in association with the determined IP address, determining whether communication failure information is found in the received result information, and attempting to create a control tunnel directed to a GGSN having the determined IP address if there is no communication failure information.

### BRIEF DESCRIPTION OF THE DRAWINGS

The above and other objects, features and other advantages of the present invention will be more clearly understood from the following detailed description of embodiments thereof taken in conjunction with the accompanying drawings, in which:

FIG. 1 is a block diagram illustrating an example of a network configuration of a general CDMA mobile communication system for providing packet data;

FIG. 2 is a block diagram illustrating an example of a conventional layered structure based on general protocols for use in individual components shown in FIG. 1;

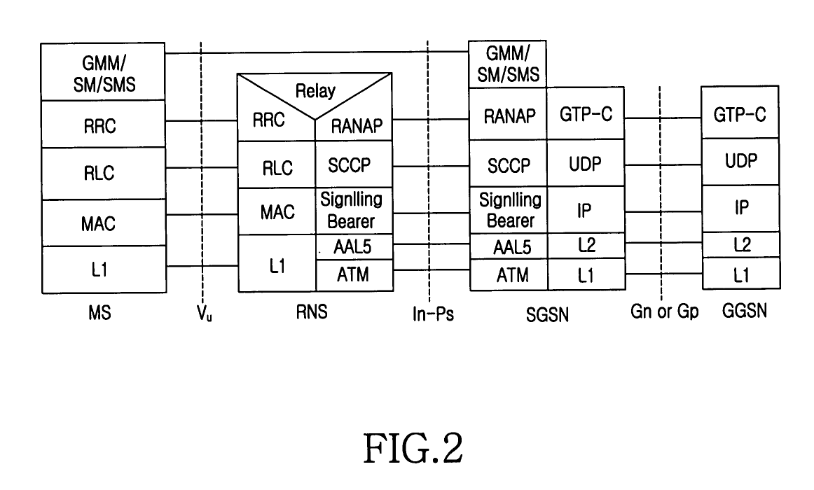

FIG. 3 is a block diagram illustrating an example of a conventional method for activating a Packet Data Protocol (PDP) context between a Service General Support Node (SGSN) system and a Gateway General Packet Radio Service (GPRS) Support Node (GGSN) system;

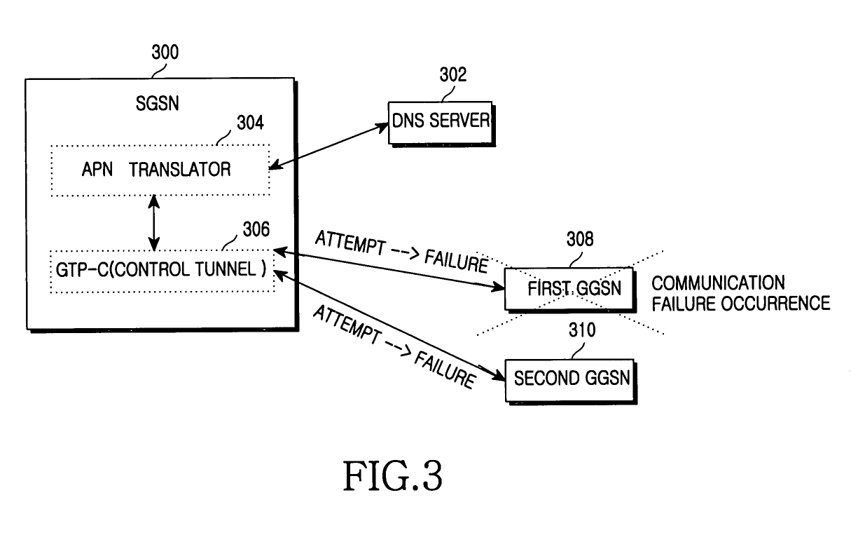

FIG. 4 is a block diagram illustrating an example of activating a PDP context between a SGSN system and a GGSN system in accordance with an embodiment of the present invention; and

FIG. 5 is a block diagram illustrating an example of activating a PDP context between a SGSN system and a GGSN system after performing the PDP context activation method shown in FIG. 4 in accordance with an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals. A detailed description of known functions and configurations has been omitted for conciseness.

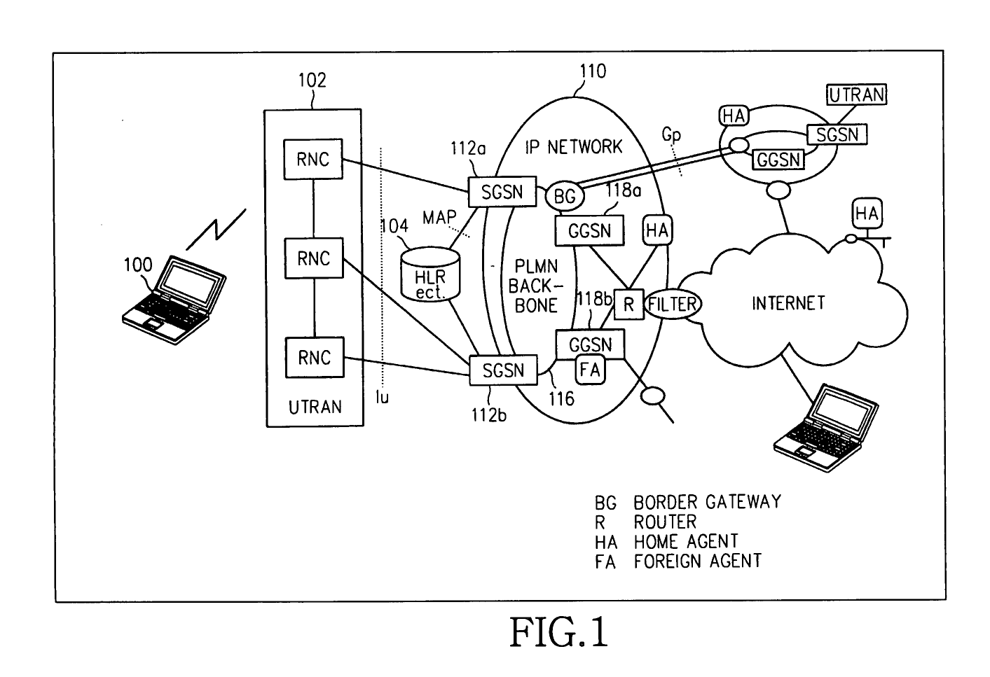

FIG. 1 is a block diagram illustrating an example of a network configuration of a Gateway General Packet Radio Service (GPRS) in a mobile communication system for providing packet data in accordance with an embodiment of the present invention.

Referring to FIG. 1, a Mobile Station (MS) 100 is connected to an (UTRAN) UMTS Terrestrial Radio Access Network (UTRAN) 102 including a plurality of Radio Network Controllers (RNCs). The UTRAN 102 is connected to a core network 110 including a plurality of Service General Support Node (SGSNs) 112a and 112b and a plurality of Gateway General Packet Radio Service (GPRS) Support Node (GGSNs) 118a and 118b. The core network 110 is connected to a packet data server (i.e., Internet server) for providing specific packet data service over the Internet. Therefore, the MS 100 activates a Packet Data Protocol (PDP) context between the GGSNs 118a and 118b to transmit or receive packet data. It should be noted that activating the PDP context, establishing a packet call, and creating a control tunnel have the same meaning. Particularly, a method for activating a PDP context between the SGSNs (112a, 112b) and the GGSNs (118a, 118b) when the MS 100 activates a PDP context between the GGSNS 118a and 118b will hereinafter be described in detail.

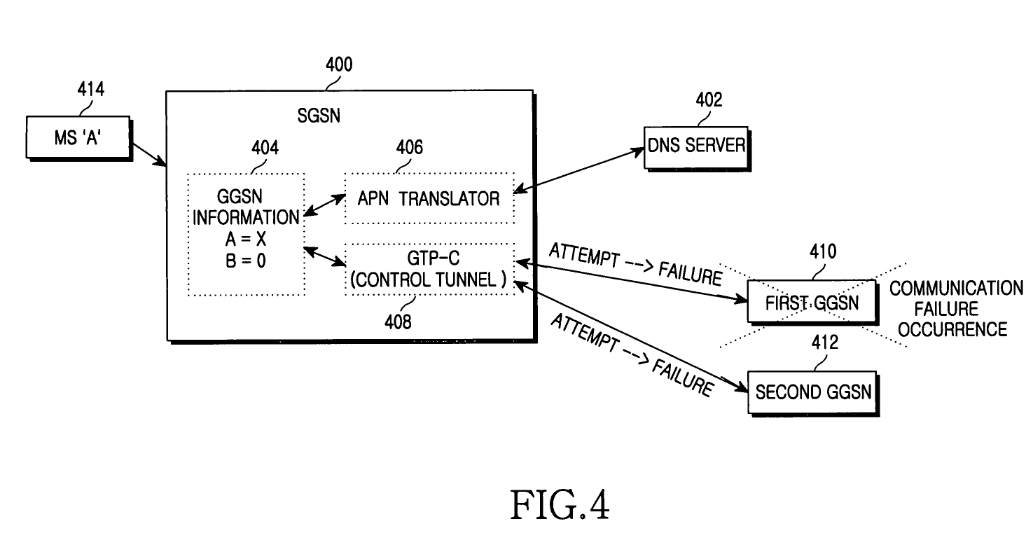

FIG. 4 is a block diagram illustrating an example of activating a PDP context between a SGSN system and a GGSN system in accordance with an embodiment of the present invention. Specifically, FIG. 4 illustrates an example for creating a control tunnel between a SGSN 400 and a plurality of GGSNs 410 and 412 in accordance with an embodiment of the present invention.

As shown in FIG. 4, the control tunnel is created upon receiving a packet data service request from a MS “A” 414.

In order to allow the MS “A” 414 to perform packet data communication with a packet data server for providing a specific packet data service, the PDP context needs to be activated. For this purpose, a PDP context also needs to be activated between the SGSN 400 and either one of GGSNs 410 and 412. In this case, the SGSN 400 exists on a path used for the specific packet data service.

Upon receiving a specific packet data service request from the MS “A” 414, an APN translator (i.e., a GMM/SM/SMS layer) 406 of the SGSN 400 converts APN information received from the MS “A” 414 into FQDN information corresponding to a packet data server for providing the specific packet data service. The APN translator 406 transmits the FQDN information to a DNS server 402, and requests information from the DNS server 402 about an IP address of a GGSN connected to the packet data server. Upon receiving the FQDN information from the APN translator 406 of the SGSN 400, the DNS server 402 searches for an IP address of a GGSN connected to a packet data server corresponding to the FQDN information on the basis of its own management information. If the DNS server 402 searches for at least one IP address, the searched IP address is transmitted to the APN translator 406 of the SGSN 400. In FIG. 4, the transmitted IP addresses are equal to IP addresses associated with the first GGSN 410 and the second GGSN 412.

The SGSN 400 stores IP addresses received from the DNS server 402 in a memory 404. Although memory 404 is shown as being located within the SGSN 400, it should be appreciated by those skilled in the art that the present invention can be practiced with memory 404 located remotely from SGSN without departing from the scope of the present invention. An exemplary structure of the memory 404 contained in the SGSN 400 is shown in the following Table 1:

TABLE 1

| APN FQDN | GGSN IP List | Failure | Last use time |
|---|---|---|---|
| xxx.yyy.mnc111.mcc450. | 10.2.20.2 | No | 20020522/120400 |
| gprs | 10.2.30.2 | Yes | 20020522/120402 |

With reference to the above Table 1, the APN FQDN indicates an address of a packet data server for providing a specific packet data service. Specifically, the APN FQDN indicates an address of a packet data server communicating with the MS “A” 414. The GGSN IP list shown in the Table 1 indicates a storage area for storing IP addresses received from the DNS server 402. The IP address “10.2.20.2” stored in the GGSN IP list is an IP address of the first GGSN 410. The other IP address “10.2.30.2” stored in the GGSN IP list is an IP address of the second GGSN 412.

The SGSN 400 attempts to create a control tunnel in a predetermined order of the IP addresses received from the DNS server 402. As shown in FIG. 4 and the Table 1, the SGSN 400 first selects a first IP address corresponding to the first GGSN 410 from among the IP addresses, and attempts to create a control tunnel using the selected first IP address. The SGSN 400 stores a prescribed time (i.e., a last attempt time) at which creating a control tunnel between the SGSN 400 and the first GGSN 410 is attempted in the memory 404. If an attempt to create the control tunnel using a GTP-C 408 of the SGSN 400 is terminated, the result information indicating whether an erroneous node was found is stored in the memory 404. The GTP-C 408 is considered to be a control tunnel generator. Referring to the Table 1, the SGSN 400 attempts to create a control tunnel associated with the first GGSN 410 at 12:04:00 on May 22, 2002. The SGSN 400 fails to create a control tunnel associated with the first GGSN 410.

If the GTP-C 408 fails to create a control tunnel associated with the first GGSN 410, it attempts to create a control tunnel associated with the second GGSN 412 corresponding to the remaining IP addresses from among the plurality of IP addresses. In this case, the SGSN 400 stores a time at which creating a control tunnel associated with the second GGSN 412 is attempted and attempt result information in the memory 404. As can be seen from the Table 1, the SGSN 400 attempts to create a control tunnel associated with the second GGSN 412 at 12:04:02 on May 22, 2002, and then successfully creates the control tunnel associated with the second GGSN 412.

According to an embodiment of the present invention, the memory 404 contained in the SGSN 400 includes an FQDN for identifying packet data servers providing specific packet data services, an IP address of at least one GGSN connected to the packet data server, a time at which creating a control tunnel is tried with respect to individual GGSNs, and the result information associated with the control tunnel creation trial, etc.

An exemplary memory structure when the SGSN 400 is connected to packet data servers providing individual packet data services is shown in the following Table 2. Specifically, the SGSN 400 is connected to three packet data servers as shown in the Table 2.

TABLE 2

| | GGSN | Result | |
|---|---|---|---|
| APN FQDN | IP List | Information | Last attempt time |
| xxx.yyy.mnc111.mcc450. | 10.2.20.2 | No | 20020522/120400 |
| gprs | | | |
| (First packet data server) | 10.2.30.2 | Yes | 20020522/120402 |
| xxx.yyy.mnc222.mcc460. | 20.2.20.2 | Yes | 20020522/120357 |
| gprs | | | |
| (Second packet data server) | | | |
| xxx.yyy.mnc333.mcc470. | 10.2.20.2 | No | 20020522/120501 |
| gprs | | | |
| (Third packet data server) | 20.2.20.2 | Yes | 20020522/120503 |

With reference to the above Table 2, the first GGSN having an IP address of 10.2.20.2 is connected to a first packet data server having an FQDN of “xxx.yyy.mnc111.mnc450.gprs” and a third packet data server having an FQDN of “xxx.yyy.mnc333.mcc470.gprs”. The second GGSN having an IP address of 10.2.30.2 is connected to the first packet data server having an FQDN of “xxx.yyy.mnc111.mnc450.gprs”. The third GGSN having an IP address of 20.2.20.2 is connected to the second packet data server having an FQDN of “xxx.yyy.mnc222.mcc460.gprs” and the third packet data server.

In substantially the same manner as Table 1, Table 2 records therein a last attempt time at which the SGSN 400 attempts to create a control tunnel associated with each IP address of the GGSNs and the result information of the control tunnel creation trial. Specifically, the SGSN 400 fails to create a control tunnel associated with the first GGSN used for a PDP context activation with the first packet data server, and then successfully creates a control tunnel associated with the second GGSN, as shown in Table 2. Table 2 shows that the SGSN 400 successfully creates a control tunnel associated with the third GGSN to perform a PDP context activation with the second packet data server. Finally, the SGSN 400 fails to create a control tunnel associated with the first GGSN used for a PDP context activation with the third packet data server, and then successfully creates a control tunnel associated with the third GGSN, as shown in the Table 2.

Although the aforementioned description relates to a PDP context activation among a plurality of packet data servers and one MS, it should be noted that such PDP context activation is available for a plurality of MSs.

Memory structures shown in Tables 1 and 2 can be applicable to the SGSN 400. However, memory 404 is illustrative of the memory structure shown in Table 1.

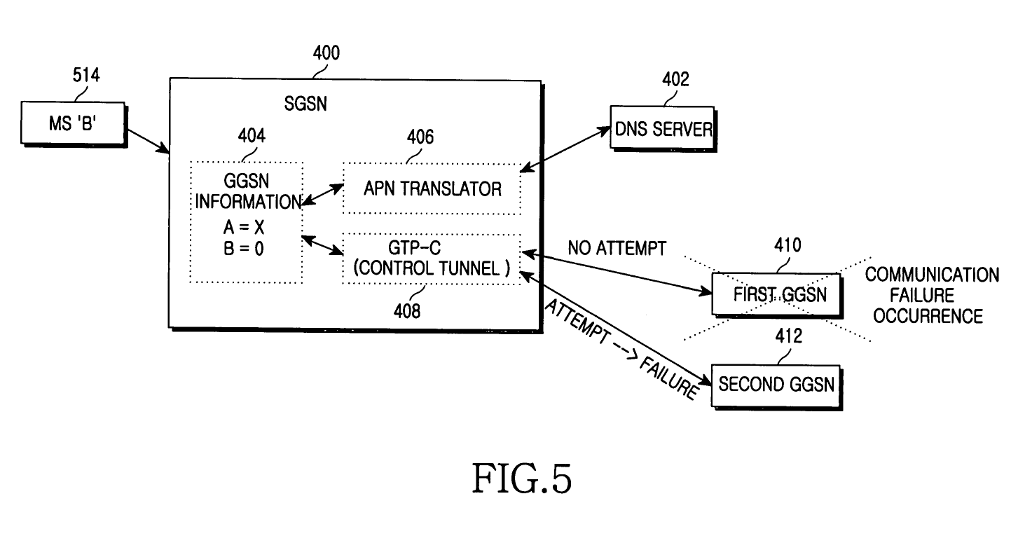

FIG. 5 is a block diagram illustrating another example of activating a PDP context between a SGSN system and a CGSN system after performing the PDP context activation method shown in FIG. 4 in accordance with an embodiment of the present invention. Specifically, FIG. 5 illustrates an example of creating a control tunnel used for packet data transmission between a SGSN 400 and a plurality of GGSNs 410 and 412 in accordance with an embodiment of the present invention. More specifically, FIG. 5 illustrates a control tunnel creation method based upon receiving a packet data service request from a packet data server managed by a memory. In this case, it is assumed that information managed by the memory is the same as those of Tables 1 and 2, and the following explanation will be described on the basis of Table 1.

Referring to FIG. 5, if a MS “B” 514 requests a packet data service of a specific packet data server, this request message of the MS “B” 514 is transmitted to the SGSN 400. The SGSN 400 converts APN information corresponding to a packet data server for providing the request packet data service over an APN translator 406 into FQDN information. Then, the SGSN 400 transmits the FQDN information to the DNS server 402 to request information from the DNS server 402 concerning an IP address of a GGSN connected to the packet data server. The DNS server 402 checks an IP address of at least one GGSN connected to the packet data server using the FQDN, and informs the SGSN 400 of the checked IP address.

Upon receiving information stored in the memory 404, the SGSN 400 determines whether the received information includes communication failure information previously created in association with the FQDN information and the IP address received from the DNS server 402. For example, this determination is performed on the assumption that the FQDN information is “xxx.yyy.mnc111.mcc450.gprs” and the DNS server 402 informs the SGSN 400 of an IP address “10.2.20.2” of the first GGSN 410 and an IP address “10.2.30.3” of the second GGSN 412. A prescribed table stored in the memory 404 refers to the Table 1. In this case, the SGSN 400 checks the result information stored in the memory 404 which is associated with the IP address of 10.2.20.2. The result information indicates whether an erroneous node (creating communication failure information) has been created while attempting to create a control tunnel to receive the same packet data service. Based on the result information of the IP address “10.2.20.2” shown in the Table 1, a control tunnel associated with the first GGSN 410 fails to create prior to a predetermined time. If such an erroneous node (i.e., communication failure information) is found upon receiving the result information associated with a corresponding IP address, the SGSN 400 checks the result information stored in the memory 404 which is associated with the IP address of 10.2.30.2. Based on the result information of the IP address “10.2.30.2” shown in the Table 1, it can be recognized that a control tunnel associated with the second GGSN 412 is successfully created prior to a predetermined time.

Because the SGSN 400 can recognize the result information previously created using the aforementioned operation, creating a control tunnel associated with the second GGSN 412 is attempted whereas creating a control tunnel associated with the first GGSN 410 is not attempted. The attempt to create such a control tunnel is performed in a GTP-C 408 contained in the SGSN 400. As a result, the SGSN 400 avoids attempting to create unnecessary control tunnels, and firstly attempts to create a control tunnel associated with a GGSN having a high possibility of creating such a control tunnel.

Information stored in the memory 404 of the SGSN 400 is reset on the basis of a predetermined time. In more detail, the last attempt time at which the SGSN 400 attempts to create a control tunnel associated with each GGSN, and its result information are reset at intervals of a predetermined time. The predetermined time is a user-defined time to be consumed for solving a communication failure generated in a specific GGSN, such that the predetermined time can be freely specified by a user. Also, the predetermined time can be differentially assigned according to individual packet data servers. Therefore, the SGSN can attempt to create a control tunnel associated with the GGSN after the lapse of the predetermined time.

As apparent from the above description, one embodiment of the present invention enables SGSN to acquire an IP address of a desired GGSN from a DNS server, and then enables the SGSN to receive result information of a corresponding GGSN from a memory over the acquired IP address. Alternatively, according to another embodiment of the present invention, the SGSN does not request information from the DNS server concerning an IP address of a desired GGSN, rather the SGSN searches for the memory using the previously-known FQDN information, and thus obtains result information of the desired GGSN. Specifically, upon receiving a specific packet data service request from a MS, the SGSN creates FQDN information associated with the packet data server for providing the requested packet data service. Then, the SGSN searches for a memory using the FQDN information, and thus obtains result information corresponding to an IP address of a corresponding GGSN. However, if there is no information managed by the memory in association with the FQDN information, the present invention performs the operations shown in FIG. 4.

Although embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for creating a control tunnel from a Service General Packet Radio Service (GPRS) Support Node (SGSN) to a Gateway GPRS Support Node (GGSN) when setting up a path for providing a specific packet data service between a Mobile Station (MS) and a packet data server in a mobile communication system for supporting a packet data service, comprising the steps of:
a) upon receiving a specific packet data service request from the MS, enabling the SGSN to determine an Internet Protocol (IP) address corresponding to at least one GGSN connected to the packet data server for providing the specific packet data service;
b) receiving control tunnel creation attempt result information managed by a memory in association with the determined IP address, and determining whether communication failure information is found in the received result information; and
c) if there is no communication failure information, enabling the SGSN to attempt to create a control tunnel directed to a GGSN having the determined IP address.

2. The method as set forth in claim 1, wherein the IP address is recognized because the SGSN finds an identifier (ID) of the packet data server and then requests information from a Domain Name System (DNS) server concerning the IP address.

3. The method as set forth in claim 2, further comprising the steps of:
d) if the packet data server ID and the control tunnel creation attempt result information associated with the IP address are not managed by the memory, controlling the SGSN to store the packet data server ID and the IP address in the memory; and
e) storing the control tunnel creation attempt result information acquired when attempting to create a control tunnel directed to the GGSN having the IP address, the control tunnel creating attempt result information being associated with the IP address.

4. The method as set forth in claim 3, wherein the SGSN determines a sequence of a plurality of IP addresses when the plurality of IP addresses are found, attempts to create a control tunnel according to the determined sequence of the IP addresses, and stores control tunnel creation attempt result information for every attempt in the memory.

5. The method as set forth in claim 4, wherein the control tunnel creation attempt result information stored in the memory further includes a predetermined time at which creating the control tunnel is attempted.

6. The method as set forth in claim 1, wherein the IP address is determined to be at least one IP identifier (ID) managed by the memory in association with an ID of the packet data server by means of the SGSN.

7. The method as set forth in claim 1, wherein the SGSN, if there are a plurality of the determined IP addresses, determines whether communication failure information is found in each control tunnel attempt result information being managed by the memory which is associated with the plurality of IP addresses, and attempts to create a control tunnel associated with only IP address having no communication failure information.

8. The method as set forth in claim 5, wherein the information managed by the memory is reset after a lapse of a predetermined time on the basis of the time at which creating the control tunnel has been attempted.

9. The method as set forth in claim 8, wherein the predetermined time is differentially assigned according to individual IP addresses if there exists a plurality of determined IP addresses.

10. An apparatus for creating a control tunnel from a Service General Packet Radio Service (GPRS) Support Node (SGSN) to a Gateway GPRS Support Node (GGSN) when setting up a path for providing a specific packet data service between a Mobile Station (MS) and a packet data server in a mobile communication system for supporting a packet data service, comprising:
an Access Point Name (APN) translator for receiving a specific packet data service request from the MS, enabling the SGSN to determine an Internet Protocol (IP) address corresponding to at least one GGSN connected to the packet data server for providing the specific packet data service;
a memory for storing an IP address of at least one GGSN according to individual identifiers (IDs) of packet data servers for previously providing packet data service, and managing control tunnel creation attempt result information associated with the IP address; and
a control tunnel creator for receiving the control tunnel creation attempt result information managed by the memory in association with the determined IP address, determining whether communication failure information is found in the received result information, and attempting to create a control tunnel directed to a GGSN having the determined IP address if there is no communication failure information.

11. The apparatus as set forth in claim 10, wherein the APN translator translates an Access Point Name (APN) to recognize the packet data server ID, transmits the obtained packet data server to a DNS server, and acquires an IP address of at least one GGSN provided from the DNS server using the packet data server ID.

12. The apparatus as set forth in claim 11, wherein the control tunnel creator controls the SGSN to store the packet data server ID and the IP address in the memory if the packet data server ID and the control tunnel creation attempt result information associated with the IP address are not managed by the memory, and stores the control tunnel creation attempt result information acquired when attempting to create a control tunnel directed to the GGSN having the IP address, the control tunnel creation attempt result information being associated with the IP address.

13. The apparatus as set forth in claim 12, wherein the control tunnel creator determines a sequence of a plurality of IP addresses when the plurality of IP addresses are found, attempts to create a control tunnel according to the determined sequence of the IP addresses, and stores control tunnel creation attempt result information for every attempt in the memory.

14. The apparatus as set forth in claim 13, wherein the control tunnel creation attempt result information stored in the memory further includes a predetermined time at which creating the control tunnel is attempted.

15. The apparatus as set forth in claim 10, wherein the IP address is determined to be at least one IP identifier (ID) managed by the memory in association with an ID of the packet data server.

16. The apparatus as set forth in claim 10, wherein the control tunnel creator, if there are a plurality of the determined IP addresses, determines whether communication failure information is found in each control tunnel attempt result information being managed by the memory which is associated with the plurality of IP addresses, and attempts to create a control tunnel associated with only IP address having no communication failure information.

17. The apparatus as set forth in claim 14, wherein the information managed by the memory is reset after a lapse of a predetermined time on the basis of the time at which creating the control tunnel has been attempted.

18. The apparatus as set forth in claim 17, wherein the predetermined time is differentially assigned according to individual IP addresses if there exists a plurality of determined IP addresses.
